(19) United States
(12) Patent Application Publication
(10) Pub. No.: US 2025/0389337 A1
(43) Pub. Date: Dec. 25, 2025

(54) FLUID VALVE

(71) Applicant: Hanon Systems, Daejeon (KR)

(72) Inventors: Jeong Wan HAN, Daejeon (KR); Shin-Won YUN, Daejeon (KR); Min Ho JANG, Daejeon (KR); Seong Woo JEONG, Daejeon (KR); Jungbum CHOI, Daejeon (KR)

(73) Assignee: Hanon Systems, Daejeon (KR)

(21) Appl. No.: 19/215,741

(22) Filed: May 22, 2025

(30) Foreign Application Priority Data
Jun. 21, 2024 (KR) 10-2024-0081446

(51) Int. Cl. F16K 11/085; F16K 27/06; F16K 27/12

(52) U.S. Cl. CPC F16K 11/0853; F16K 27/065; F16K 27/12

(57) ABSTRACT

A fluid valve according to the present disclosure may include a main body having a plurality of communication holes formed collinearly in an outer surface thereof in a height direction, and a cover covering each of upper and lower portions of the main body, wherein the plurality of communication holes may be selectively connected to form a plurality of flow paths inside the main body, and the plurality of flow paths may be separated by a separation surface.

### CROSS REFERENCE TO RELATED APPLICATION

The present application claims priority to Korean Patent Application No. 10-2024-0081446, filed Jun. 21, 2024, the entire contents of which is incorporated herein for all purposes by this reference.

### BACKGROUND OF THE INVENTION

### Field of the Invention

The present disclosure relates to a heat valve for a vehicle.

### Description of the Related Art

Recently, the demand for electric vehicles as eco-friendly vehicles without concerns about air pollution has been increasing significantly.

In general, vehicles using internal combustion engines use valves to control a flow of coolant to cool an engine and the like, but since electric vehicles use the electric energy of battery packs installed therein, it is important to maintain the temperature of a temperature-sensitive battery within a predetermined range.

In particular, since batteries have the characteristics that their charge or discharge capacity rapidly decreases at a specific temperature or lower or higher, the battery packs installed in an electric vehicle need to be always maintained within a predetermined temperature range.

The temperature control of the battery pack is mainly done using coolant, and in this way, to control the temperature of the battery pack using coolant, a coolant valve that changes a flow direction of coolant according to operational conditions of a vehicle is essential.

### RELATED ART DOCUMENT

[Patent Document] Korean Patent Registration No. 10-2179242 (Nov. 16, 2020)

### SUMMARY OF THE INVENTION

The present disclosure is directed to providing a fluid valve in which a plurality of flow paths along which a fluid can flow can be formed in a single fluid valve.

According to the present disclosure, there is provided a fluid valve including a main body having a plurality of communication holes formed collinearly in an outer surface thereof in a height direction, and a cover covering each of upper and lower portions of the main body, wherein the plurality of communication holes are selectively connected to form a plurality of flow paths inside the main body, and

the plurality of flow paths are separated by a separation surface.

In addition, the plurality of communication holes may be formed at set intervals with respect to a center of the main body.

In addition, the separation surface may have an inclined surface toward a center of the main body and the plurality of flow paths may be separated by the separation surface.

In addition, the plurality of flow paths may be divided into upper and lower layers inside the main body by the separation surface.

In addition, the separation surface may have an uneven shape that is curved vertically in a height direction of the plurality of communication holes so that the plurality of communication holes belong to a flow path belonging to the upper layer and a flow path belonging to the lower layer inside the main body.

In addition, the plurality of flow paths may be divided by a plurality of vertical partitions.

In addition, the plurality of vertical partitions may have an upper vertical partition formed on the upper layer and a lower vertical partition formed on the lower layer in the height direction of the main body.

In addition, the plurality of flow paths may be composed of an upper flow path formed by the separation surface and the upper vertical partition and a lower flow path formed by the separation surface and the lower vertical partition.

In addition, the upper flow path and the lower flow path may be formed to be partitioned at the same height.

In addition, at least one of the plurality of upper flow paths may be formed to surround an outside of another flow path so that the plurality of upper flow paths do not overlap each other.

In addition, the number of upper flow paths and the number of lower flow paths may be formed asymmetrically.

In addition, the number of upper flow paths may be formed to be greater than the number of lower flow paths.

In addition, the plurality of communication holes may be formed at set intervals radially with respect to the center of the main body.

In addition, the upper vertical partition may be attached to an upper cover covering the upper portion of the main body and the lower vertical partition may be attached to a lower cover covering the lower portion of the main body.

In addition, a connector may be provided at a center of the main body to rotate the main body.

In addition, an upper buffer part, which is a space sealed by the plurality of the upper vertical partitions, may be formed between the plurality of the upper flow paths.

In addition, a lower buffer part, which is a space sealed by the plurality of the lower vertical partitions, may be formed between the plurality of the lower flow paths.

In addition, the plurality of communication holes may be formed as twelve or more communication holes.

In addition, the plurality of communication holes may be formed as twelve communication holes.

In addition, the upper flow path may be formed as four flow paths by connecting a pair of eight communication holes.

In addition, the lower flow path may be formed to have two flow paths by connecting a pair of four communication holes.

### BRIEF DESCRIPTION OF THE DRAWINGS

FIG. 1 is a perspective view of a fluid valve according to the present disclosure.

FIG. 2 is a perspective view illustrating a flow path formed on an upper layer of a fluid valve according to the present disclosure.

FIG. 3 is a perspective view illustrating only the inside of a main body in FIG. 2.

FIG. 4 is a perspective view illustrating a flow path formed on a lower layer of the fluid valve according to the present disclosure.

FIG. 5 is a perspective view illustrating only the inside of the main body in FIG. 4.

FIG. 6 is a perspective view illustrating a flow of a fluid along a flow path formed on the upper layer of the fluid valve according to the present disclosure.

FIG. 7 is a perspective view illustrating a flow path formed on the lower layer of the fluid valve according to the present disclosure.

FIG. 8 is a conceptual diagram illustrating a flow of a fluid along an upper flow path and a lower flow path.

FIG. 9 is a view illustrating paths of the upper flow path and the lower flow path together.

FIG. 10 is a view illustrating a path of the upper flow path.

FIG. 11 is a view illustrating a path of the lower flow path.

### DETAILED DESCRIPTION OF THE INVENTION

Hereinafter, the present disclosure will be described in detail with reference to the accompanying drawings. However, this is merely exemplary, and the present disclosure is not limited to specific embodiments exemplarily described.

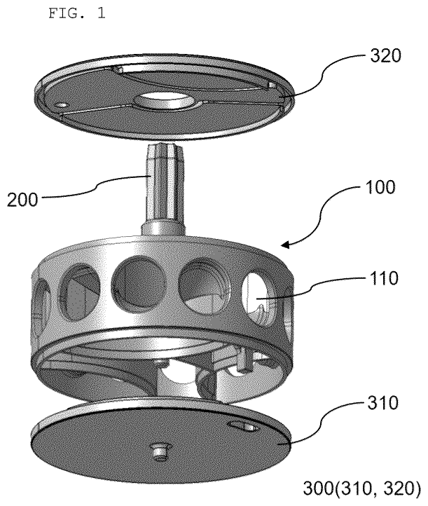

Referring to FIGS. 1 to 5, a fluid valve according to the present disclosure may include a main body 100, a connector 200, and a cover 300.

The main body 100 may form a plurality of communication holes 110 collinearly in an outer surface thereof in a height direction.

The main body 100 may have a cylindrical shape, and the inside thereof may have a space that forms a flow path. A plurality of flow paths 140 may be formed in the space, and the plurality of flow paths 140 may be formed by selectively connecting the plurality of communication holes 110.

The plurality of communication holes 110 may be formed at set intervals set with respect to a center 101 of the main body 100.

In addition, the plurality of communication holes 110 may be formed at set intervals radially from the center 101 of the main body 100.

The main body 100 may have the connector 200 at the center 101 of the main body 100. The connector 200 may be connected to a driver (not illustrated) to rotate the main body 100.

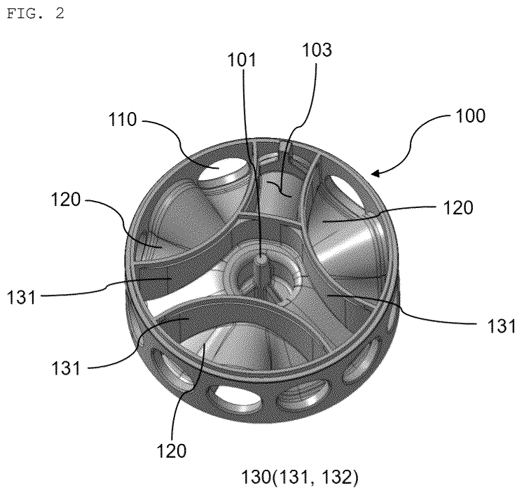

Referring to FIGS. 2 to 4, the plurality of communication holes 110 may be selectively connected to form the plurality of flow paths 140 inside the main body 100.

The plurality of flow paths 140 may have inclination toward the center of the main body 100 and may be divided by a separation surface 120 having an uneven shape in a circumferential direction and a plurality of vertical partitions 130.

The plurality of flow paths 140 may be divided into upper and lower layers inside the main body 100 by the separation surface.

The separation surface 120 may have an uneven shape in the circumferential direction that divides the plurality of communication holes 110 so that the plurality of communication holes 110 belong to a flow path belonging to the upper layer and a flow path belonging to the lower layer inside the main body 100.

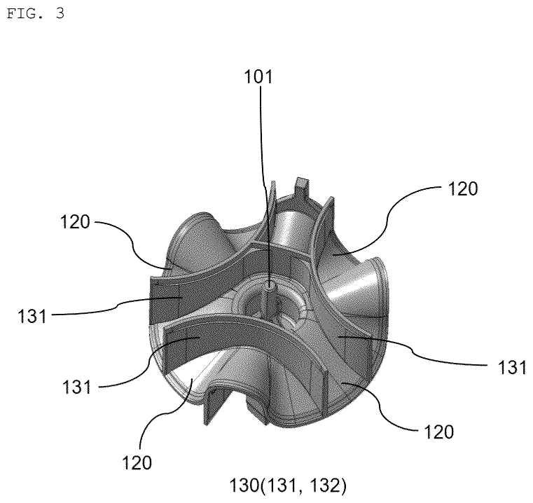

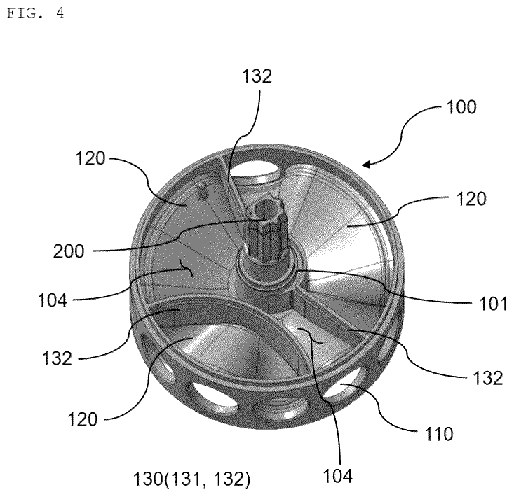

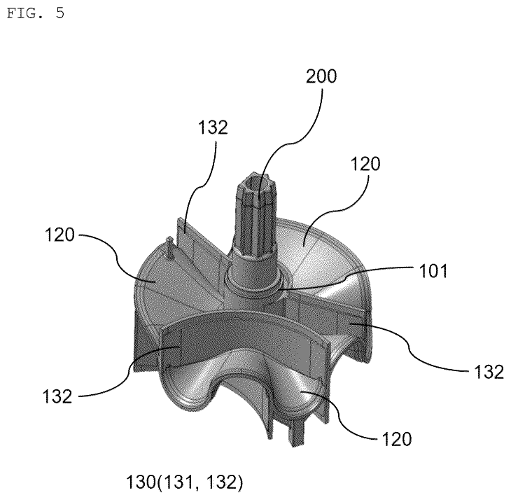

FIGS. 2 and 3 illustrate an upper flow path 141 in the main body 100, and FIGS. 4 and 5 illustrates a lower flow path 142 in the main body 100. The separation surface 120 may be formed inside the main body 100 in the circumferential direction of the main body 100 to divide the flow path 140 into the upper and lower layers.

The plurality of communication holes 110 have a height difference or are not actually divided into layers, but are disposed collinearly at the same height on the circumference. Accordingly, the separation surface 120 may have an uneven shape that is curved vertically in a height direction of the communication hole 110 in order to divide the plurality of communication holes 110 located at the same height into the upper and lower layers.

The plurality of communication holes 110 may separately belong to each of the flow path 141 belonging to the upper layer and the flow path 142 belonging to the lower layer by the separation surface 120 having the uneven shape.

The separation surface 120 may form inclination toward the center of the main body 100. In each of the upper layer of FIG. 2 and the lower layer of FIG. 4, the separation surface 120 may form inclination that decreases in height from the circumference of the main body 100 toward the center of the main body 100.

Accordingly, it is possible to reduce the flow resistance of the flow path, thereby ensuring the smooth flow of the fluid.

The plurality of vertical partitions 130 may be formed as an upper vertical partition 131 and a lower vertical partition 132, respectively, in an axial direction of the main body 100.

The vertical partition 130 may be composed of the upper vertical partition 131 and the lower vertical partition 132.

The vertical partition 130 may separately form a plurality of flow paths 141 formed on the upper layer of the main body 100 and separately form a plurality of flow paths 142 formed on the lower layer of the main body 100. The upper vertical partition 131 may separately form the flow paths 141 belonging to the upper layer, and the lower vertical partition 132 may separately form the flow paths 142 belonging to the lower layer.

FIG. 3 illustrates the upper vertical partition 131, and FIG. 5 illustrates the lower vertical partition 132. The upper vertical partition 131 may be formed to protrude from the separation surface 120 toward an upper cover 310, and the lower vertical partition 132 may be formed to protrude from the separation surface 120 toward a lower cover 320.

Here, the upper and lower layers are terms used for convenience in order to identify the locations of the flow paths formed inside the main body 100, and the upper and lower layers may be interchanged.

The upper vertical partition 131 may be attached to the upper cover 310 covering an upper portion of the main body 100, and the lower vertical partition 132 may be attached to the lower cover 320 covering a lower portion of the main body 100. This enables the formation of an independent flow path by covering the main body 100 with the cover 300 and prevents the fluid from leaking outward from the main body 100.

The vertical partition 130 and the cover 300 may be attached by adhesion or fusion.

The vertical partition 130 may partition a space of the upper or lower layer and divide the flow path 140 into a plurality of flow paths. The vertical partition 130 may selectively include and partition some of all of the communication holes 110 to form the flow path 140.

The plurality of flow paths 140 may be composed of the upper flow path 141 formed by the separation surface 120 and the upper vertical partition 131 and the lower flow path 142 formed by the separation surface 120 and the lower vertical partition 132.

Each of the plurality of upper flow paths 141 and lower flow paths 142 may have a buffer part. Referring to FIG. 2, an upper buffer part 103, which is a space sealed by the plurality of upper vertical partitions 131, may be formed between the plurality of upper flow paths 141, and referring to FIG. 4, a lower buffer part 104, which is a space sealed by the plurality of lower vertical partition 132, may be formed between the plurality of lower flow paths 142.

The upper buffer part 103 and the lower buffer part 104 are spaces in which a fluid formed between the plurality of flow paths 140 does not flow and may form buffer spaces between adjacent flow paths. Accordingly, it is possible to prevent heat transfer from occurring between adjacent flow paths.

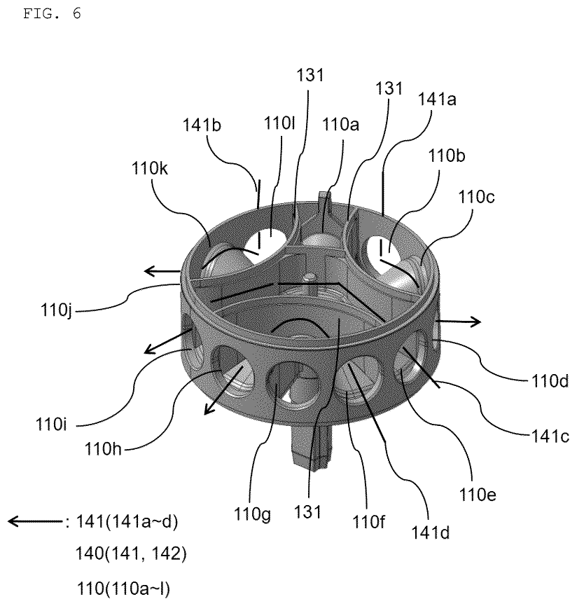

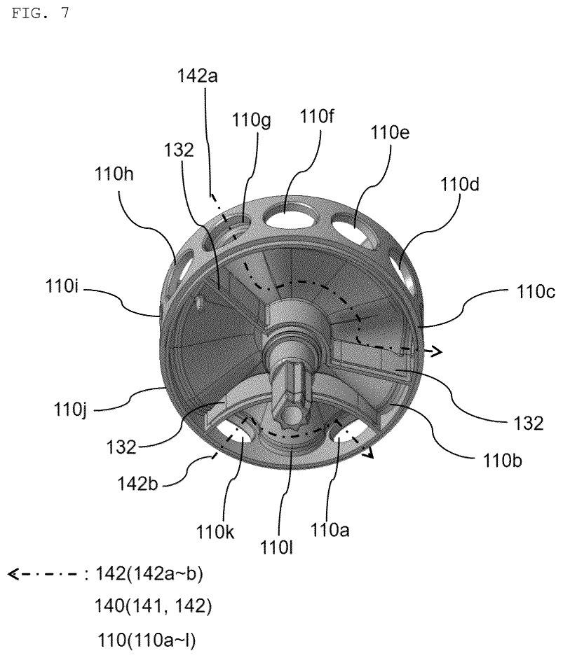

FIG. 6 illustrates the upper flow path 141, and FIG. 7 illustrates the lower flow path 142. The plurality of flow paths 140 may be formed by being divided into the upper flow paths 141 and the lower flow paths 142 inside the main body 100. The upper flow path 141 and the lower flow path 142 may also be formed to have first to fourth upper flow paths 141a to 141d and first and second lower flow paths 142a and 142b, respectively, which are separated.

Referring to FIGS. 6 and 7, the communication hole 110 may be composed of twelve first to twelfth communication holes 110a to 110l. The upper flow path 141 may be formed as four upper flow paths 141a to 141d, and the lower flow path 142 may be formed as two lower flow paths 142a and 142b. A first upper flow path 141a may be connected to a second communication hole 110b and a fourth communication hole 110d, a second upper flow path 141b may be connected to a tenth communication hole 110j and a twelfth communication hole 110l, a third upper flow path 141c may be connected to a fifth communication hole 110e and a ninth communication hole 110i, and a fourth upper flow path 141d may be connected to a sixth communication hole 110f and an eighth communication hole 110h. In addition, a first lower flow path 142a may be connected to a third communication hole 110c and a seventh communication hole 110g, and a second lower flow path 142b may be connected to the first communication hole 110a and an eleventh communication hole 110k.

In this case, the first upper flow path 141a may be formed by the upper vertical partition 131 connecting the fourth communication hole 110d to the fifth communication hole 110e between the first communication hole 110a and the second communication hole 110b, the second upper flow path 141b may be formed by the upper vertical partition 131 connecting the ninth communication hole 110i to the tenth communication hole 110j between the first communication hole 110a and the twelfth communication hole 110l, and the third upper flow path 141c and the fourth upper flow path 141d may be formed by the upper vertical partition 131 connecting the eighth communication hole 110h to the ninth communication hole 110i between the third communication hole 110c and the fourth communication hole 110d.

In addition, the first lower flow path 142a may be formed by the lower vertical partition 132 connecting the center 101 between the second communication hole 110b and the third communication hole 110c and the lower vertical partition 132 connecting the center 101 between the seventh communication hole 110g and the eighth communication hole 110h, and the second lower flow path 142b may be formed by the lower vertical partition 132 connecting the tenth communication hole 110j to the eleventh communication hole 110k between the first communication hole 110a and the second communication hole 110b.

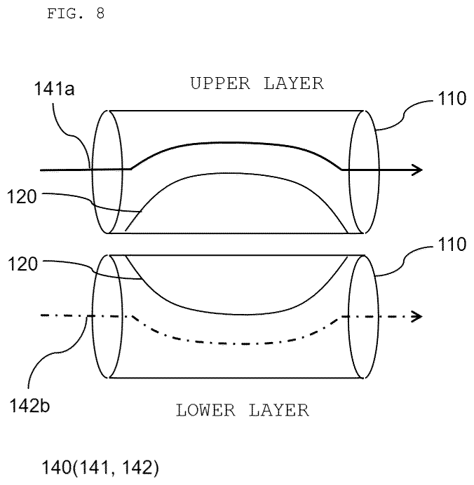

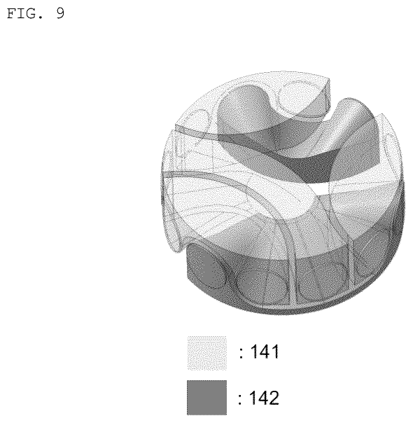

FIGS. 8 and 9 illustrate flow paths of a plurality of upper flow paths 141 formed on the upper layer and a plurality of lower flow paths 142 formed on the lower layer.

First, referring to FIG. 8, the upper flow path 141 and the lower flow path 142 may form flow paths without overlapping each other in a thickness direction of the main body 100. In addition, referring to FIG. 9, each of the upper flow path 141 and the lower flow path 142 may form a plurality of independent flow paths along which a fluid separately flows.

That is, the upper flow path 141 and the lower flow path 142 may overlap each other in the axial direction of the main body 100, but may be formed to be divided by the separation surface 120 and the vertical partition 130. With such a structure, it is possible to reduce a height of the main body 100, thereby reducing a height of the entire fluid valve.

Since at least one of the plurality of upper flow paths 142 may be formed to surround the outside of another flow path, the plurality of upper flow paths 142 may not overlap each other.

According to the arrangement of the separation surface 120 and the vertical partition 130, the number of flow paths of the upper and lower layers of the main body 100 may be different to flexibly correspond to the settings of the number of flow paths and the path of the flow path.

In this case, the number of upper flow paths 141 and lower flow paths 142 may be asymmetrically formed. In addition, the number of upper flow paths 141 may be formed to be greater than the number of lower flow paths 142. This is advantageous in terms of a degree of freedom when designing a fluid valve and can also have an advantageous effect in reducing the size of the fluid valve.

The plurality of communication holes 110 may be formed as twelve or more communication holes in the main body 100.

The number of flow paths 140 may also be determined according to the number of communication holes 110, and flow paths of various paths may be formed according to the separation surface 120 and the vertical partition 130.

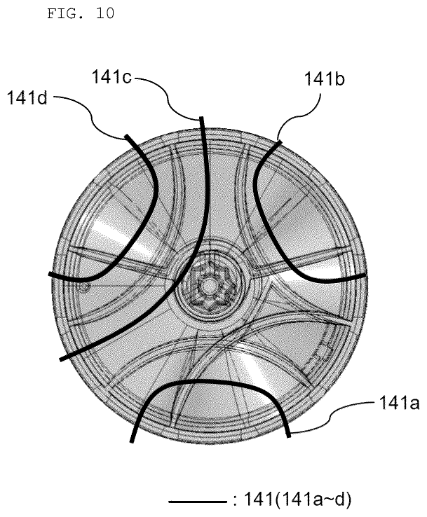

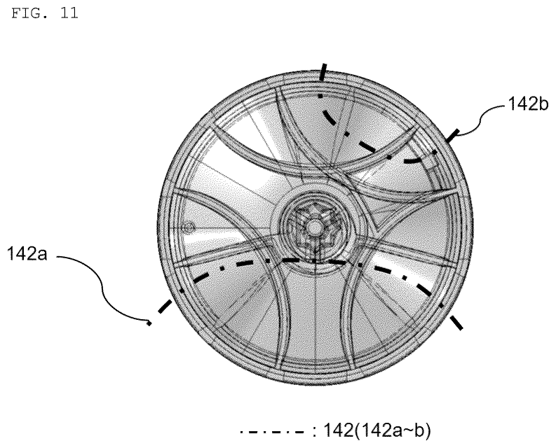

The above embodiment has been described based on the case in which the communication hole is formed as twelve communication holes 110. Referring to FIGS. 10 and 11, it can be seen that four upper flow paths 141 are formed on the upper layer of the main body 100 and two lower flow paths 142 are formed on the lower layer.

This is an embodiment that may be derived when the communication hole is formed as twelve communication holes 110, and the paths and number of flow paths may vary. In addition, when the number of communication holes 110 is changed, the paths and number of flow paths may also be changed.

In this way, in the fluid valve according to the present disclosure, it is possible to smoothly distribute the fluid by forming the plurality of communication holes 110 formed at the same height in the main body 100 on different layers inside the main body 100 to form the plurality of flow paths 140.

In addition, the upper flow path 141 and the lower flow path 142 overlap each other in the axial direction of the main body 100, but have a structure that is formed by being divided by the separation surface 120 and the vertical partition 130, thereby reducing the height of the main body 100 and reducing the height of the entire fluid valve.

In addition, by configuring the upper and lower flow paths divided inside the main body 100 not to overlap each other in the thickness direction of the main body 100, it is possible to increase the flow cross-sectional area of the flow path and the flow resistance of the fluid, thereby enabling the smooth flow of the fluid.

According to the present disclosure, it is possible to smoothly distribute a fluid by forming the plurality of flow paths by forming the plurality of communication holes formed at the same height in the main body on different layers.

In addition, it is possible to reduce the size of the main body in the height direction by partitioning the flow path at the same height inside the main body.

The above embodiments of the present disclosure are merely exemplary, and those skilled in the art to which the present disclosure pertains will be able to well understand that various modifications and other equivalent embodiments are possible therefrom. Accordingly, it should be understood that the present disclosure is not limited to the forms described in the above detailed description. Accordingly, the true technical scope of the present disclosure should be determined by the technical spirit of the appended claims. In addition, it should be understood that the present disclosure includes all modifications, equivalents, and substitutes within the spirit and scope of the present disclosure as defined by the appended claims.

### DESCRIPTION OF REFERENCE NUMERALS

100: main body
101: center
110: communication hole
120: separation surface
130: vertical partition
131: upper vertical partition
132: lower vertical partition
140: flow path
141: upper flow path
142: lower flow path
200: connector
300: cover
310: upper cover
320: lower cover

What is claimed is:

1. A fluid valve comprising:
a main body having a plurality of communication holes formed collinearly in an outer surface thereof in a height direction; and
a cover covering each of upper and lower portions of the main body,
wherein the plurality of communication holes are selectively connected to form a plurality of flow paths inside the main body, and
the plurality of flow paths are separated by a separation surface.

2. The fluid valve of claim 1, wherein the plurality of communication holes are formed at set intervals with respect to a center of the main body.

3. The fluid valve of claim 1, wherein the separation surface has an inclined surface toward a center of the main body, and the plurality of flow paths are separated by the separation surface.

4. The fluid valve of claim 3, wherein the plurality of flow paths are divided into upper and lower layers inside the main body by the separation surface.

5. The fluid valve of claim 4, wherein the separation surface has an uneven shape that is curved vertically in a height direction of the plurality of communication holes so that the plurality of communication holes belong to a flow path belonging to the upper layer and a flow path belonging to the lower layer inside the main body.

6. The fluid valve of claim 5, wherein the plurality of flow paths are divided by a plurality of vertical partitions.

7. The fluid valve of claim 6, wherein the plurality of vertical partitions have an upper vertical partition formed on the upper layer and a lower vertical partition formed on the lower layer in the height direction of the main body.

8. The fluid valve of claim 7, wherein the plurality of flow paths are composed of an upper flow path formed by the separation surface and the upper vertical partition and a lower flow path formed by the separation surface and the lower vertical partition.

9. The fluid valve of claim 8, wherein the upper flow path and the lower flow path are formed to be partitioned at the same height.

10. The fluid valve of claim 8, wherein at least one of the plurality of upper flow paths is formed to surround an outside of another flow path so that the plurality of upper flow paths do not overlap each other.

11. The fluid valve of claim 8, wherein the number of upper flow paths and the number of lower flow paths are formed asymmetrically.

12. The fluid valve of claim 11, wherein the number of upper flow paths is formed to be greater than the number of lower flow paths.

13. The fluid valve of claim 2, wherein the plurality of communication holes are formed at set intervals radially with respect to the center of the main body.

14. The fluid valve of claim 7, wherein the upper vertical partition is attached to an upper cover covering the upper portion of the main body, and the lower vertical partition is attached to a lower cover covering the lower portion of the main body.

15. The fluid valve of claim 1, wherein a connector is provided at a center of the main body to rotate the main body.

16. The fluid valve of claim 8, wherein an upper buffer part, which is a space sealed by the plurality of the upper vertical partitions, is formed between the plurality of the upper flow paths.

17. The fluid valve of claim 8, wherein a lower buffer part, which is a space sealed by the plurality of the lower vertical partitions, is formed between the plurality of the lower flow paths.

18. The fluid valve of claim 13, wherein the plurality of communication holes are formed as twelve or more communication holes.

19. The fluid valve of claim 18, wherein the upper flow path is formed to have four flow paths by connecting a pair of eight communication holes.

20. The fluid valve of claim 18, wherein the lower flow path is formed to have two flow paths by connecting a pair of four communication holes.
